(19) United States
(12) Patent Application Publication
(10) Pub. No.: US 2015/0095941 A1
(43) Pub. Date: Apr. 2, 2015

(54) MULTILINGUAL AUDIO SERVICE SUPPORTING SYSTEM AND METHOD THEREFOR

(71) Applicant: Electronics and Telecommunications Research Institute, Daejeon (KR)

(72) Inventors: CHANG KI KIM, Daejeon (KR); JAE HO KIM, Gyeryong-si Chungcheongnam-do (KR); TAE JUNG KIM, Daejeon (KR); JU IL JEON, Daejeon (KR); JEONG JU YOO, Daejeon (KR); JIN WOO HONG, Daejeon (KR)

(21) Appl. No.: 14/502,290

(22) Filed: Sep. 30, 2014

(30) Foreign Application Priority Data
Oct. 1, 2013 (KR) 10-2013-0117544
Jun. 30, 2014 (KR) 10-2014-0081375

(51) Int. Cl. H04N 21/81; H04N 21/41; H04N 21/45; H04N 21/43; H04N 21/434; H04N 21/439; H04N 21/435

(52) U.S. Cl. CPC H04N 21/8106; H04N 21/439; H04N 21/4104; H04N 21/435; H04N 21/4305; H04N 21/4341; H04N 21/4532
USPC 725/32

(57) ABSTRACT

A multilingual audio service supporting system and a method thereof which allow multiple viewers using different languages to watch the same TV program based on a multiplatform. The system may include a content data providing device, a multilingual audio data providing device, a content image output device, and a multilingual audio output device. Audios in various languages, in time synchronization with main content, are provided through multilingual audio output devices in the vicinity to the content image output device, so that new broadcast-associated multilingual audio services can be provided.

### CROSS-REFERENCE TO RELATED APPLICATION(S)

This application claims priority from Korean Patent Application Nos. 10-2013-0117544, filed on Oct. 1, 2013, and 10-2014-0081375, filed on Jun. 30, 2014, in the Korean Intellectual Property Office, the disclosures of which are incorporated herein by references in its entirety.

### BACKGROUND

1. Field

The following description relates to a multilingual audio broadcasting service supporting method and system which allow users using various languages to watch the same TV program through a multiplatform-based content providing device.

2. Description of the Related Art

Convergence between broadcasting and the Internet derived from the advent of smart TV and IPTV technology enables the provision of hybrid broadcasting services that offer additional content and two-way content over the Internet, allowing users to view the broadcast content.

In addition, a multiscreen service is being developed, based on a home network, allowing content and services for a user to be provided through multiple screens.

Also, a multiplatform-based multiscreen broadcasting service that incorporates the multiscreen service and existing hybrid broadcasting in which broadcast content and the Internet are combined on the same TV screen is in progress of standardization through next-generation hybrid broadcast broadband (Hbb TV 2.0), Open Hybrid TV (OHTV 2.0) and the like, and its trial run is carried out.

### SUMMARY

In one general aspect, there is provided a content image output device including: a content data extractor configured to extract content image data, content time information, and content metadata from content data that has been multiplexed with the content metadata and the content time information, and confirm a multilingual audio service available to be provided, based on the extracted content metadata; a user information acquirer receiver configured to receive information about a user's content to output of the confirmed multilingual audio service to the user and information about a specific language to be provided; an audio data acquirer configured to, with the user's consent to provision of service, search for multilingual audio data corresponding to the extracted content metadata and download or stream the found multilingual audio data; and a multilingual audio data transmitter configured to search for multilingual data output devices capable of outputting the multilingual audio service, connect to a multilingual audio output device selected from the found multilingual output devices, and transmit the multilingual audio data and the content time information to the connected multilingual output device.

The user information acquirer may include a user consent information acquirer configured to receive information about user's consent to the multilingual audio service and a detailed information acquirer configured to receive from the user information containing a specific language in which the multilingual audio service is provided.

In another general aspect, there is provided a multilingual audio output device including: a service provision receiver configured to download or stream multilingual audio data, receive content time information, output information about multilingual audio services available to be provided to a user, and acquire information about whether the user consents to provision of the multilingual audio services; and a multilingual audio service provider configured to, with the user's consent, output, to the user, multilingual audio data in synchronization with currently output content image using the content time information.

The multilingual audio output device may further include: a content data providing device configured to provide content data that has multiplexed with content metadata and content time information; a multilingual audio data providing device configured to download or stream the multilingual audio data to the content image providing device; and a content image output device configured to extract content image data, the content metadata, and the content time information from the received multiplexed content data, output the content image data to the user, download or stream particular multilingual audio data that has been confirmed as corresponding to the content metadata, and transmit the downloaded or streamed multilingual audio data to a connectable multilingual audio output device.

the content data providing device may include: a content metadata creator configured to create metadata of content to be provided; a content time information creator configured to create information about the content to be provided which includes image reproduction information, audio reproduction information and time information containing information about synchronization between images and audio over time; and a multiplexer configured to multiplex the created content metadata and content time information with content data.

The content image output device may include: a content data extractor configured to extract the content image data, the content time information and the content metadata from the multiplexed content data, and confirm a multilingual audio service available to be provided, based on the extracted content metadata; a user information acquirer configured to receive information about a user's content to output of the confirmed multilingual audio service to the user and information about a specific language to be provided; an audio data acquirer configured to, with the user's content to provision of service, search for multilingual audio data corresponding to the extracted content metadata and download or stream the found multilingual audio data; and a multilingual audio data transmitter configured to search for multilingual data output devices capable of outputting the multilingual audio service, connect to a multilingual audio output device selected from the found multilingual output devices, and transmit the multilingual audio data and the content time information to the connected multilingual output device.

The user information acquirer may include: a user consent information acquirer configured to receive information about user's consent to the multilingual audio service; and a detailed information acquirer configured to receive from the user information containing a specific language in which the multilingual audio service is provided.

In another general aspect, there is provided a method of outputting multilingual audio, including: downloading or streaming multilingual audio data, receiving content time information, outputting information about multilingual audio services available to be provided to a user, and acquiring information about whether the user consents to provision of the multilingual audio services; and with the user's consent, outputting, to the user, multilingual audio data in synchronization with currently output content image using the content time information.

The method may further include: providing content data that has multiplexed with content metadata and content time information; downloading or streaming the multilingual audio data to the content image providing device; and extracting content image data, the content metadata, and the content time information from the received multiplexed content data, outputting the content image data to the user, downloading or streaming particular multilingual audio data that has been confirmed as corresponding to the content metadata, and transmitting the downloaded or streamed multilingual audio data to a connectable multilingual audio output device.

The providing of the content data may include creating metadata of content to be provided; creating information about the content to be provided which includes image reproduction information, audio reproduction information, and time information containing information about synchronization between images and audio over time; and multiplexing the created content metadata and content time information with content data.

The transmitting of the downloaded or streamed multilingual audio service to the multilingual audio output device may include: extracting the content image data, the content time information and the content metadata from the multiplexed content data, and confirming a multilingual audio service available to be provided, based on the extracted content metadata; receiving information about a user's content to output of the confirmed multilingual audio service to the user and information about a specific language to be provided; with the user's content to provision of service, searching for multilingual audio data corresponding to the extracted content metadata and downloading or streaming the found multilingual audio data; and searching for multilingual data output devices capable of outputting the multilingual audio service, connecting to a multilingual audio output device selected from the found multilingual output devices, and transmitting the multilingual audio data and the content time information to the connected multilingual output device.

The receiving of the information may include receiving information about user's consent to the multilingual audio service and receiving from the user information containing a specific language in which the multilingual audio service is provided.

Other features and aspects will be apparent from the following detailed description, the drawings, and the claims.

### BRIEF DESCRIPTION OF THE DRAWINGS

FIG. 1 is a diagram illustrating a multilingual audio service supporting system according to an exemplary embodiment.

FIG. 2 is a diagram illustrating in detail the content data providing device 100 of FIG. 1.

FIG. 3 is a table showing a format of the content metadata created in FIG. 2.

FIG. 4 is a diagram illustrating in detail the content image output device of FIG. 1.

FIG. 5 is a diagram illustrating in detail the user information acquirer of FIG. 4.

FIG. 6 is a diagram illustrating in detail the multilingual audio output device of FIG. 1.

FIG. 7 is a flowchart illustrating a process of a multilingual audio service supporting system according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The terms “comprises” and/or “comprising” as used herein will be understood to mean that the list following is non-exhaustive and may or may not include any other additional suitable items, for example one or more further component(s), operation(s), procedure(s), and/or element(s) as appropriate.

Hereinafter, a multilingual audio service supporting system and a method therefor will be described with reference to accompanying drawings.

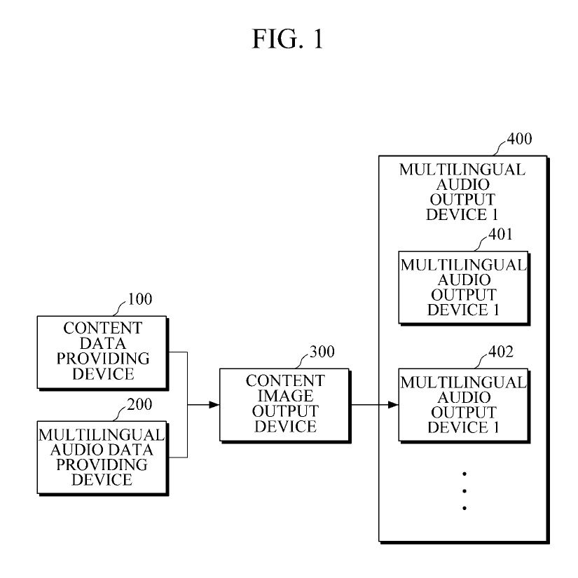

FIG. 1 is a diagram illustrating a multilingual audio service supporting system according to an exemplary embodiment.

Referring to FIG. 1, the multilingual audio service supporting system 1000 may include a content data providing device 100, a multilingual audio data providing device 200, a content image output device 300, and a multilingual audio output device 400.

The content data providing device 100 may provide content metadata, content time information, and multiplexed content data.

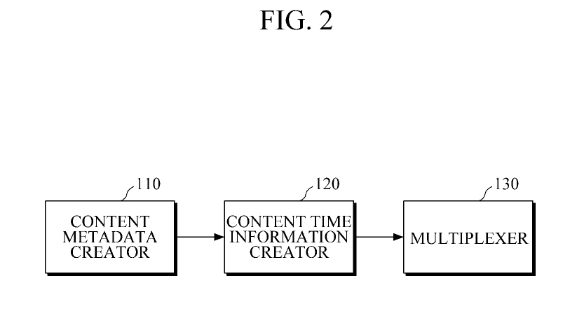

The content data providing device 100 will be described in detail with reference to FIG. 2.

In response to receiving a request from the content image output device 300, which has recognized multilingual audio data, the multilingual data providing device 200 may download or stream corresponding multilingual audio data to the content image output device 300.

The multilingual audio data providing device 200 may be a device that is capable of downloading or streaming particular multilingual audio data to the content image output device 300.

The content image output device 300 may extract content image data, content metadata, and content time information data from received multiplexed content data.

In addition, the content image output device 300 may output the extracted content image data to the user, download or stream particular multilingual audio data that has been confirmed as corresponding to the content metadata, and transmit the downloaded or streamed multilingual audio data to a connectable multilingual audio output device.

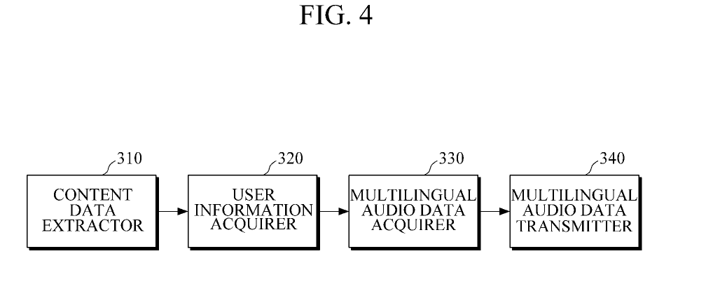

The content image output device 300 will be described in detail with reference to FIG. 4.

The multilingual audio output device 400 may download or stream the multilingual audio data, receive the content time information, acquire information containing the user's consent to the provision of multilingual audio service, and output the multilingual audio data in synchronization with currently output content images.

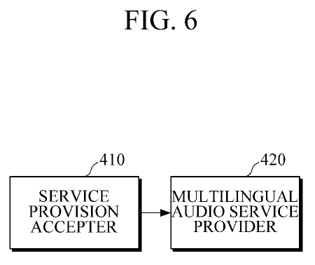

The multilingual audio output device 400 will be described in detail with reference to FIG. 6.

FIG. 2 is a diagram illustrating in detail the content data providing device 100 of FIG. 1.

Referring to FIG. 2, the content data providing device 100 may include a content metadata creator 110, a content time information creator 120, and a multiplexer 130.

The content metadata creator 110 may create content metadata of content to be provided.

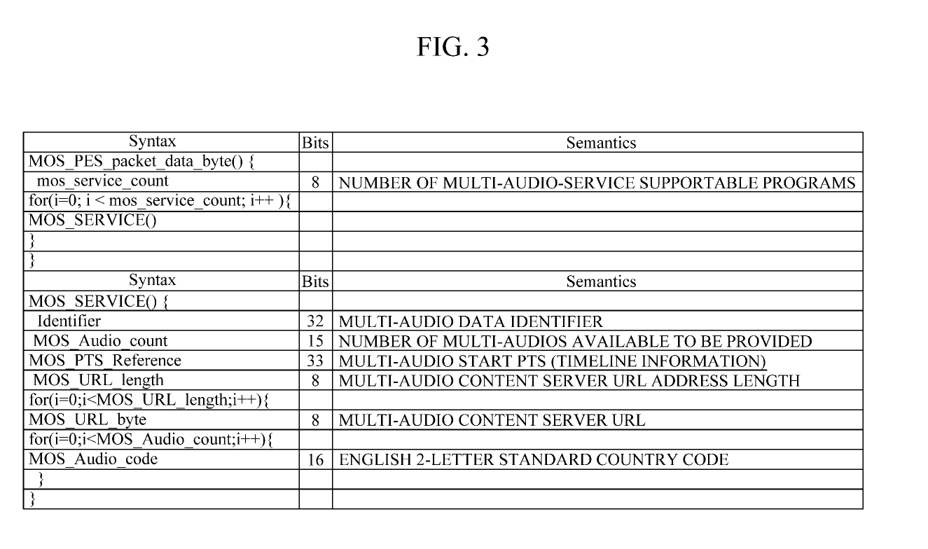

In the exemplary embodiment, the content metadata may be created as shown in FIG. 3.

The content time information creator 120 may create information about content to be provided, which includes image reproduction information, voice reproduction information and time information containing information about synchronization between images and voice-over time.

The synchronization may refer to synchronizing the output time of an image output task and an audio output task in each time section.

In the exemplary embodiment, the synchronization information may be information required in matching execution time of each task in order to perform the synchronization as described above.

The multiplexer 130 may multiplex the created content metadata and content time information with content data.

FIG. 3 is a table showing a format of the content metadata created in FIG. 2.

FIG. 3 shows the format of content metadata and content time information.

A universal resource locator (URL) of a multilingual audio data providing device 200, the number of multi-audios available to be provided and a country code of a country where a multilingual audio service can be provided may be included.

Also, a presentation time stamp as a reference for representing each content may be contained in the content time information.

FIG. 4 is a diagram illustrating in detail the content image output device of FIG. 1.

Referring to FIG. 4, the content image output device 300 may include a content data extractor 310, a user information acquirer 320, a multilingual audio data acquirer 330, and a multilingual audio data transmitter 340.

The content data extractor 310 may extract content image data, the content time information, and the content metadata from the content multiplexed with the content metadata and the content time information, and, based on the extracted content metadata, confirm a multilingual audio service available to be provided.

The user information acquirer 320 may receive a user's consent to output the confirmed multilingual audio service to the user and information about a specific language in which the multilingual audio service is offered.

In response to the user's consent to the provision of service, the multilingual audio data acquirer 330 may search for multilingual audio data corresponding to the extracted content metadata and download or stream the found multilingual audio data.

The multilingual audio data transmitter 340 may search for multilingual output devices capable of outputting the multilingual audio service, connect to a multilingual audio output device selected from the found multilingual output devices, and transmit multilingual audio data and content time information to the connected multilingual output device.

Wire/wireless-based UPnP mechanism may be employed to search for the multilingual audio output device 400 capable of providing the multilingual audio service to the user, and the aspects of the present disclosure are not limited thereto.

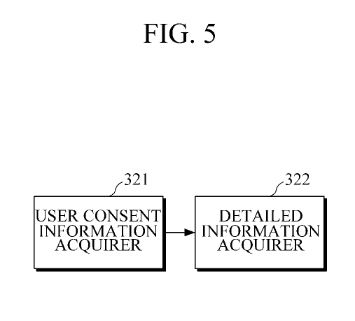

FIG. 5 is a diagram illustrating in detail the user information acquirer of FIG. 4.

Referring to FIG. 5, the user information acquirer 320 may include a user consent information acquirer 321 and a detailed information acquirer 322.

The user consent information acquirer 321 may receive information about a user's consent to the multilingual audio service.

The detailed information acquirer 322 may receive, from the user, information containing a specific language in which the multilingual audio service is offered.

The detailed information needed for providing the multilingual audio service may include, but not limited to, information about a specific language that the user has chosen and information about detailed settings of multilingual audio data to be provided.

The information about the detailed settings of the multilingual audio data may include, but not limited to, information about a multilingual audio data section needed by the user and information about multi-audio sound volume to be output.

FIG. 6 is a diagram illustrating in detail the multilingual audio output device of FIG. 1.

Referring to FIG. 6, the multilingual audio output device 400 may include a service provision accepter 410 and a multilingual audio service provider 420.

The service provision receiver 410 may download or stream the multilingual audio data, receive the content time information, and output information about multilingual audio services available to be provided to the user.

The service provision receiver 410 may obtain information containing the consent to the provision of multilingual audio service.

With the user's consent, the multilingual audio service provider 420 may output the multilingual audio data in synchronization with currently output content image to the user by utilizing the content time information.

The multilingual audio service provider 420 may reproduce the downloaded or streamed multilingual audio data in precise synchronization with the image output from the content image output device 300.

In this example, network time protocol (NTP) may be used for the synchronization, and the aspects of the present disclosure are not limited thereto.

In addition, streaming between the two devices may be based on various http-based streaming protocol and-real time streaming protocol/real-time transport protocol (RTSP/RTP), and the aspects of the present disclosure are not limited thereto.

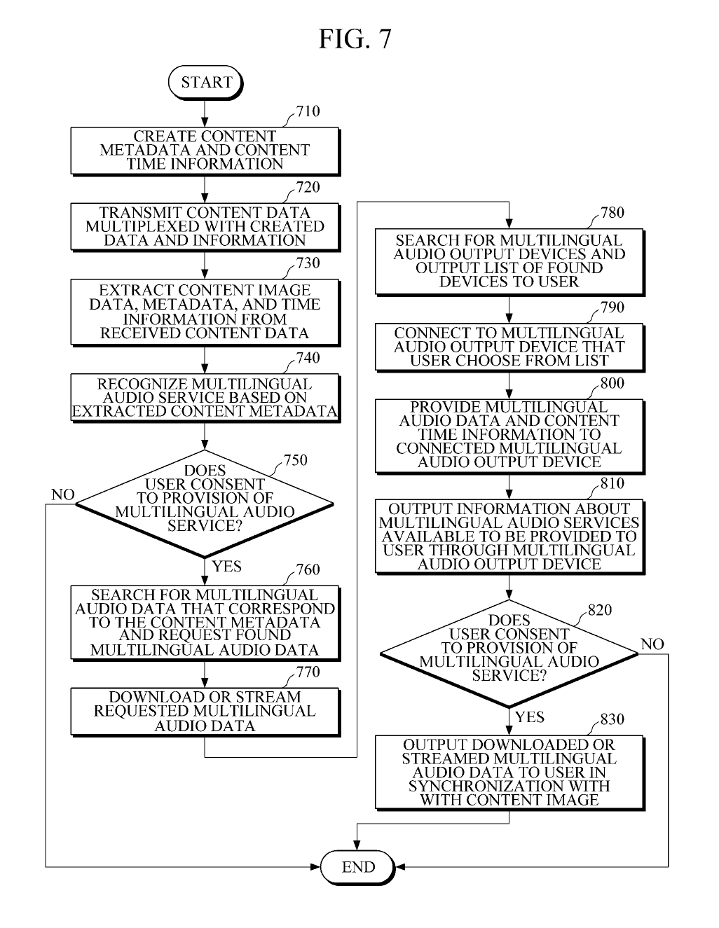

FIG. 7 is a flowchart illustrating a process of a multilingual audio service supporting system according to an exemplary embodiment.

In 710, content metadata and content time information are created.

According to the exemplary embodiment, the content metadata and the content time information may be created, the created content metadata and content time information may be multiplexed with content data, and the resulting multiplexed content data may be provided.

In 720, the content data multiplexed with the created data and information is transmitted.

Content image data, content metadata, and the content time information are extracted from the received content data in 730.

According to the exemplary embodiment, the image data may be extracted from the content data multiplexed with the content metadata and time information, and then be output to the user, and also the content time information and content metadata may be extracted from the content data.

In 740, a multilingual audio service that corresponds to the content metadata is recognized.

In 750, it is determined whether the user consents to the provision of the recognized multilingual audio service.

According to the exemplary embodiment, information containing information about the user's consent to the provision of the recognized multilingual audio service and detailed information needed for providing the multilingual audio service is received for the determination of the user's consent.

In 760, multilingual audio data that corresponds to the content metadata is searched for, and then the found multilingual audio data is requested.

According to the exemplary embodiment, with the user's consent to provide the multilingual audio service, multilingual audio data may be searched in a multilingual audio service server based on the extracted content metadata, and then the found multilingual audio data may be requested to be downloaded or streamed from the server.

In 770, the requested multilingual audio data is downloaded or streamed.

In 780, multilingual audio output devices are searched for, and a list of found devices is output to the user.

According to the exemplary embodiment, multilingual audio devices capable of providing the multilingual audio service to the user may be searched for and a list of the found multilingual audio output devices may be output to the user.

In 790, the system is connected to a multilingual audio output device that the user has chosen from the output list.

In 800, the multilingual audio data and the content time information are provided to the connected multilingual audio output device.

According to the exemplary embodiment, multilingual audio data containing a specific language chosen by the user and the time information may be provided to the connected multilingual audio output device.

In 810, information about multilingual audio services available to be provided to the user is output through the multilingual audio output device.

In 820, it is determined whether the user contents to the provision of multilingual audio service.

According to the exemplary embodiment, information related to the multilingual audio service to be provided may be output to the user, and the user may input the consent to the provision of multilingual audio service based on the output information.

In 830, the content time information is received, and the multilingual audio data is downloaded or streamed and is output to the user in synchronization with the content image.

According to the exemplary embodiment, multilingual audio data in the language chosen by the user may be downloaded or streamed, and then be output to the user in synchronization with the content image.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A content image output device comprising:
a content data extractor configured to extract content image data, content time information, and content metadata from content data that has been multiplexed with the content metadata and the content time information, and confirm a multilingual audio service available to be provided, based on the extracted content metadata;
a user information acquirer receiver configured to receive information about a user's content to output of the confirmed multilingual audio service to the user and information about a specific language to be provided;
an audio data acquirer configured to, with the user's consent to provision of service, search for multilingual audio data corresponding to the extracted content metadata and download or stream the found multilingual audio data; and
a multilingual audio data transmitter configured to search for multilingual data output devices capable of outputting the multilingual audio service, connect to a multilingual audio output device selected from the found multilingual output devices, and transmit the multilingual audio data and the content time information to the connected multilingual output device.

2. The content image output device of claim 1, wherein the user information acquirer comprises: a user consent information acquirer configured to receive information about user's consent to the multilingual audio service; and a detailed information acquirer configured to receive from the user information containing a specific language in which the multilingual audio service is provided.

3. A multilingual audio output device comprising:
a service provision receiver configured to download or stream multilingual audio data, receive content time information, output information about multilingual audio services available to be provided to a user, and acquire information about whether the user consents to provision of the multilingual audio services; and
a multilingual audio service provider configured to, with the user's consent, output, to the user, multilingual audio data in synchronization with currently output content image using the content time information.

4. The multilingual audio output device of claim 3, further comprising:
a content data providing device configured to provide content data that has multiplexed with content metadata and content time information;
a multilingual audio data providing device configured to download or stream the multilingual audio data to the content image providing device; and
a content image output device configured to extract content image data, the content metadata, and the content time information from the received multiplexed content data, output the content image data to the user, download or stream particular multilingual audio data that has been confirmed as corresponding to the content metadata, and transmit the downloaded or streamed multilingual audio data to a connectable multilingual audio output device.

5. The multilingual audio output device of claim 4, wherein the content data providing device comprises: a content metadata creator configured to create metadata of content to be provided; a content time information creator configured to create information about the content to be provided which includes image reproduction information, audio reproduction information and time information containing information about synchronization between images and audio over time; and a multiplexer configured to multiplex the created content metadata and content time information with content data.

6. The multilingual audio output device of claim 4, wherein the content image output device comprises:
a content data extractor configured to extract the content image data, the content time information and the content metadata from the multiplexed content data, and confirm a multilingual audio service available to be provided, based on the extracted content metadata;
a user information acquirer configured to receive information about a user's content to output of the confirmed multilingual audio service to the user and information about a specific language to be provided;
an audio data acquirer configured to, with the user's content to provision of service, search for multilingual audio data corresponding to the extracted content metadata and download or stream the found multilingual audio data; and
a multilingual audio data transmitter configured to search for multilingual data output devices capable of outputting the multilingual audio service, connect to a multilingual audio output device selected from the found multilingual output devices, and transmit the multilingual audio data and the content time information to the connected multilingual output device.

7. The multilingual audio output device of claim 6, wherein the user information acquirer comprises: a user consent information acquirer configured to receive information about user's consent to the multilingual audio service; and a detailed information acquirer configured to receive from the user information containing a specific language in which the multilingual audio service is provided.

8. A method of outputting multilingual audio, comprising:
downloading or streaming multilingual audio data, receiving content time information, outputting information about multilingual audio services available to be provided to a user, and acquiring information about whether the user consents to provision of the multilingual audio services; and
with the user's consent, outputting, to the user, multilingual audio data in synchronization with currently output content image using the content time information.

9. The method of claim 8, further comprising:
providing content data that has multiplexed with content metadata and content time information;
downloading or streaming the multilingual audio data to the content image providing device; and
extracting content image data, the content metadata, and the content time information from the received multiplexed content data, outputting the content image data to the user, downloading or streaming particular multilingual audio data that has been confirmed as corresponding to the content metadata, and transmitting the downloaded or streamed multilingual audio data to a connectable multilingual audio output device.

10. The method of claim 9, wherein the providing of the content data comprises creating metadata of content to be provided; creating information about the content to be provided which includes image reproduction information, audio reproduction information, and time information containing information about synchronization between images and audio over time; and multiplexing the created content metadata and content time information with content data.

11. The method of claim 9, wherein the transmitting of the downloaded or streamed multilingual audio service to the multilingual audio output device comprises:
extracting the content image data, the content time information and the content metadata from the multiplexed content data, and confirming a multilingual audio service available to be provided, based on the extracted content metadata;
receiving information about a user's content to output of the confirmed multilingual audio service to the user and information about a specific language to be provided;
with the user's content to provision of service, searching for multilingual audio data corresponding to the extracted content metadata and downloading or streaming the found multilingual audio data; and
searching for multilingual data output devices capable of outputting the multilingual audio service, connecting to a multilingual audio output device selected from the found multilingual output devices, and transmitting the multilingual audio data and the content time information to the connected multilingual output device.

12. The method of claim 11, wherein the receiving of the information comprises receiving information about user's consent to the multilingual audio service and receiving from the user information containing a specific language in which the multilingual audio service is provided.
